(19) United States
(12) Patent Application Publication
(10) Pub. No.: US 2006/0266908 A1
(43) Pub. Date: Nov. 30, 2006

(54) Retractable hanger

(76) Inventor: Joy Tong, Ft. Lauderdale, FL (US)

Correspondence Address: BACON & THOMAS, PLLC, 625 SLATERS LANE, FOURTH FLOOR, ALEXANDRIA, VA, 22314, US

(21) Appl. No.: 11/135,376

(22) Filed: May 24, 2005

(51) Int. Cl. B25G 1/00

(52) U.S. Cl. 248/339; 248/317

(57) ABSTRACT

A retractable hanger allowing assembly or disassembly as desired includes a base, an adapter, and a rod; a through hole being disposed at the center of the base with one gap being each provided on both inner walls therein; a locking channel being provided on the inner circumference of the through hole; a locking bit each extending from both sides at the top of the adapter and a recess being provided at the bottom of the adapter to receive insertion of the rod; and the base being fixed and mounted with the rod by means of the locking bit and the locking channel.

### BACKGROUND OF THE INVENTION

(a) Field of the Invention

The present invention is related to a retractable hanger, and more particularly, to one that with its hanging angle adjustable and particularly applicable for the use to hang a bag attached to a trunk.

(b) Description of the Prior Art

The prior art as told in U.S. Pat. Nos. 6,830,148; 6,830,228; 6,830,156; 6,854,610; 6,854,561; 6,820,868; 6,739,557; and 6,695,276, relates to a hanger that provides proper positioning purpose by means of a hooker to allow hanging or fetching of an object as desired.

### SUMMARY OF THE INVENTION

The primary purpose of the present invention is to provide a retractable hanger that includes a base, an adapter, and a rod with the base fixed to a selected location in ceiling fashion, the adapter being connected to the head of the rod and latched to the base.

Another purpose of the present invention is to provide a hanger with both ends of the rod respectively connected to one adapter for the application of the rod in lateral mode in conjunction with two bases thus for the hanger to be mounted to a trunk for hanging a bag attached to the trunk.

Another purpose yet of the present invention is to provide a hanger that has both sides on the top of the adapter extending each a locking bit to be latched to a locking channel provided on the inner circumference of a through hole disposed in the base to secure both of the adapter and the hooker from the base in position.

Another purpose yet of the present invention is to provide a hanger that has at the top of the adapter disposed with an additional elastic member to further firmly secure the adapter in the base without falling off when the adapter is latched to the base.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a perspective view of an adapter in the preferred embodiment of the present invention.

FIG. 4 is a sectional view of the preferred embodiment of the present invention.

FIGS. 5 and 6 are schematic views showing mutual engagement between a locking bit of the adapter and a locking channel of a base in the preferred embodiment of the present invention.

FIG. 7 is a schematic view showing another preferred embodiment of the present invention having a hook provided to the tail of a rod.

FIG. 8 is a schematic view showing that the present invention is applied to a trunk.

FIG. 9 is a perspective view showing that the present invention is laterally applied.

FIG. 10 is an exploded view showing another preferred embodiment of the present invention.

FIG. 11 is a schematic view showing another preferred embodiment yet of the present invention with an additional coil provided to an adapter.

FIG. 12 is a schematic view showing another preferred embodiment yet of the present invention with an additional elastic member of rubber provided to the adapter.

### DETAILED DESCRIPTION OF THE PREFERRED EMBODIMENTS

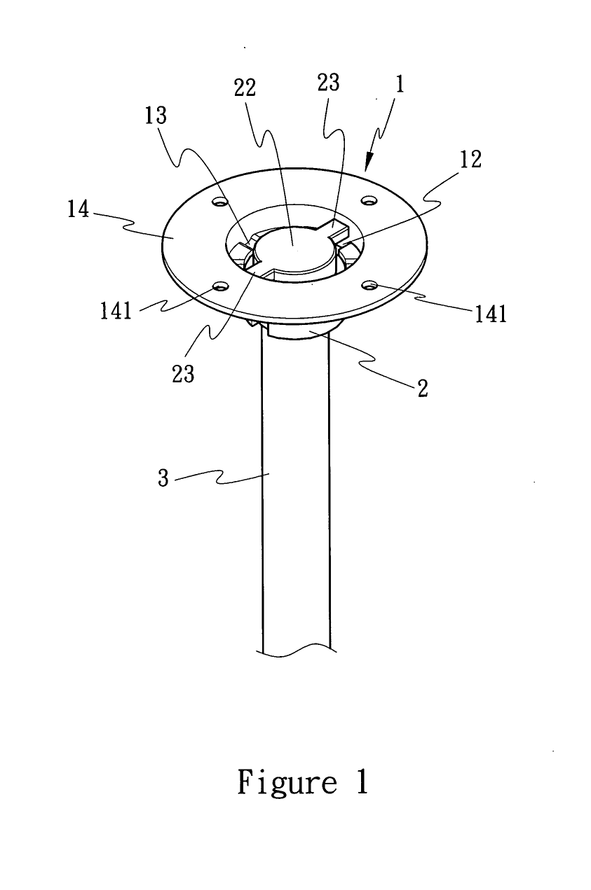

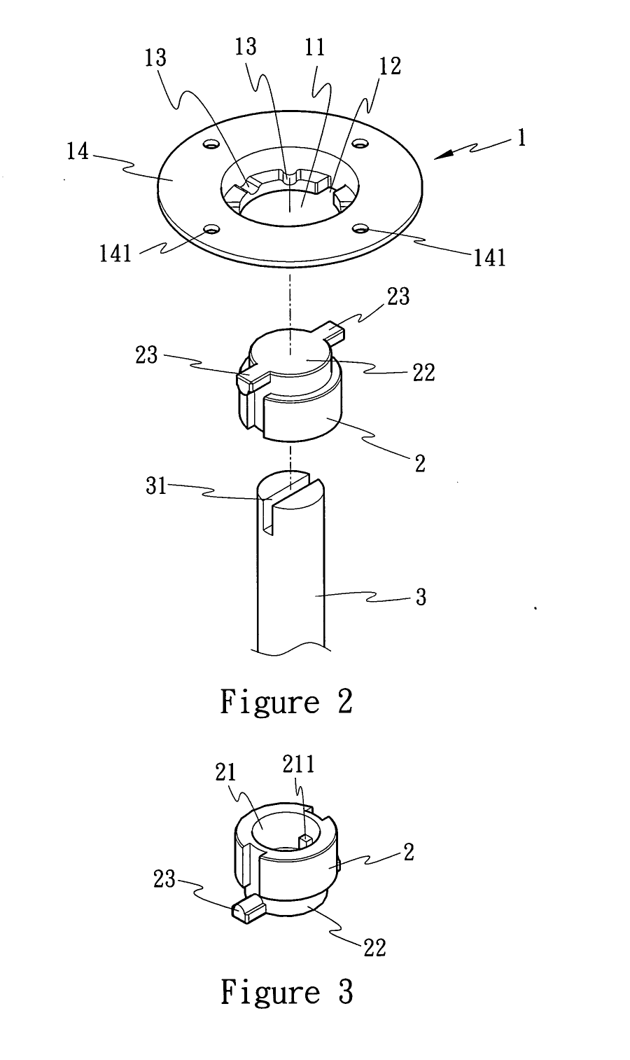

Referring to FIGS. 1, 2, and 3, a preferred embodiment of the present invention is essentially comprised of a base 1, an adapter 2, and a rod 3. Wherein, the base 1 related to a disk shaped base has at its center disposed with a through hole 11, two gaps 12 provided on both sides of the inner wall of the through hole 11, multiple locking channels 13 (as illustrated in FIG. 2) disposed on inner circumference of the through hole 11 and arranged in radius with the through hole 11 as center, each locking channel 13 related to a semi-circular shape in recess, and a flange 14 disposed with multiple locking holes 141.

The adapter 2 as illustrated in FIGS. 2 and 3 roughly indicating a nut has provided at its lower end a recess 21, one or a plurality of limiting bit 211 on the inner wall at the bottom of the recess 21, a cap 22 on the upper end of the adapter 2 in a diameter slightly shorter than that of the adapter 2, and a locking bit 23 each having a rounded inner end protruding from both sides of the top of the cap 22.

The rod 3 to hang an object 4 is made in a diameter corresponding to that of the recess 21, and one or a plurality of a slot 31 to match the limiting bit 211 is cut at the top of rod 3.

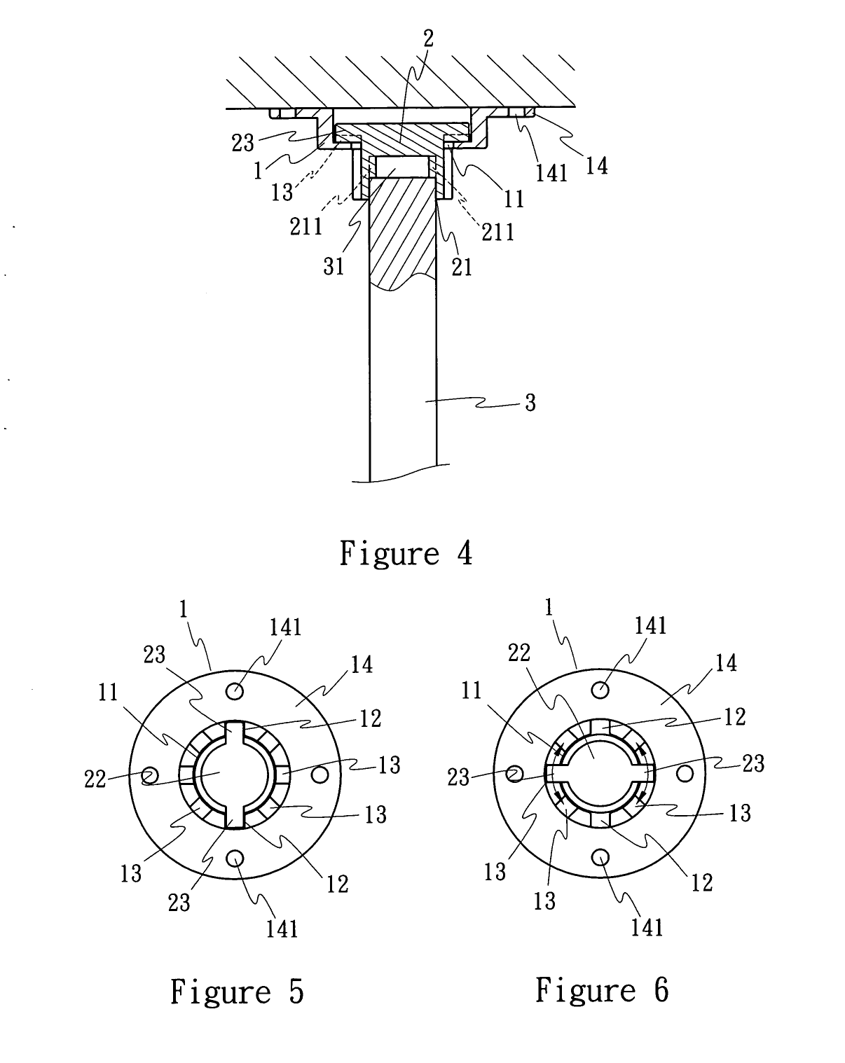

When assembled, the base 1 with its locking holes 141 provided on the flange 14 is fixed in a ceiling fashion as illustrated in FIG. 4. The head of the rod 3 is inserted into the recess 21 of the adapter 2 to such that both of the limiting bit 211 and the slot 31 are engaged to each other. The locking bit 23 of the adapter 2 penetrates through both gaps 12 in the through hole 11. The rod 3 is turned to rotate together with the adapter 2 for the locking bit 23 to be latched in a selected locking channel 13 as illustrated in FIGS. 5 and 6 to form the hanger to suspend the object 4 with its hanging angle adjustable.

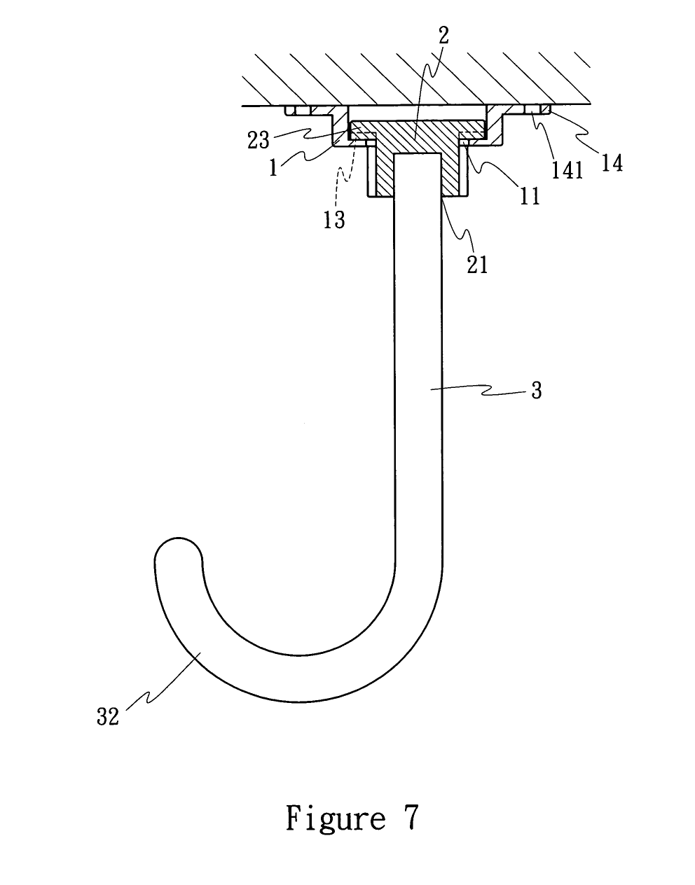

Furthermore the present invention allows vertical hanging and lateral hanging as applicable. When the base 1 is fixed in the ceiling fashion for vertical suspension of the object 4 (as that provided in a closet), the tail of the rod 3 is made in a-shape of a hooker 32 as illustrated in FIG. 7. Accordingly, when the rod 3 is connected to the base 1 through the adapter 2 to provide a hanger, the hooker 32 is used to suspend the object 4 in the vertical hanging mode. When the hanger is not used, the rod 3 may be removed for storage to keep a nice appearance for the space where the hanger is fixed.

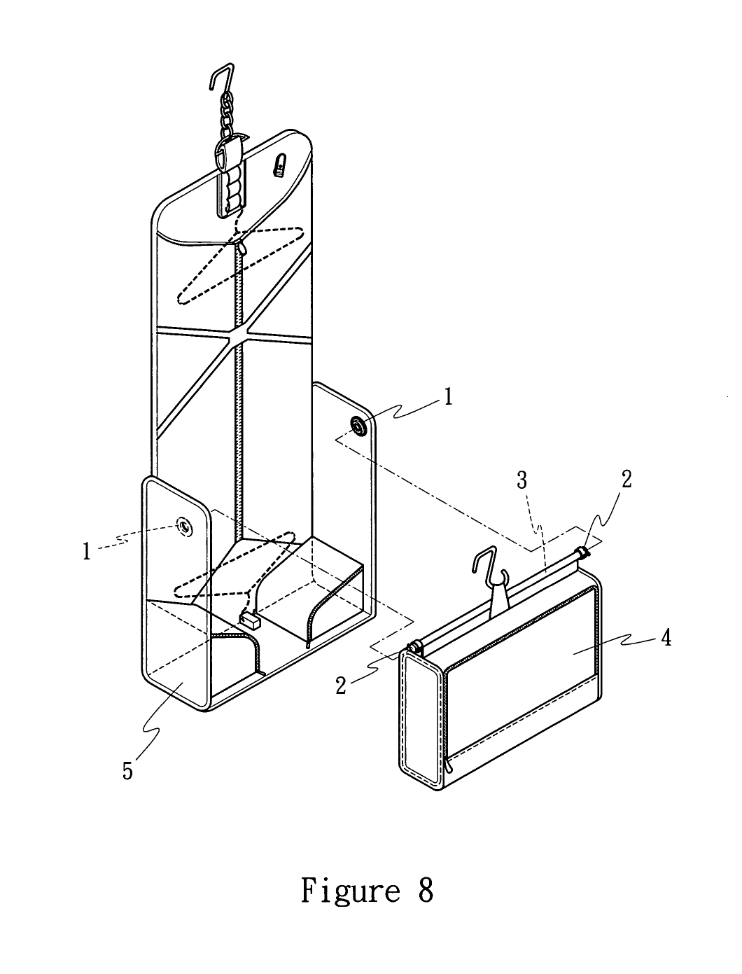

In its lateral hanging mode, both ends of the rod 3 are respectively connected with the adapter 2 in conjunction with two bases 1 for the application. As illustrated in FIG. 8, the present invention is applied to a trunk 5. Two bases 1 are fixed to the inner edge of the opening of the trunk 5. The object 4 (a bag attached to the trunk) is put on the rod 3 first and two adapters 2 respectively connected to both ends of the rod 3. Once the locking bit 23 passes through two gaps 12 provided on both inner sides of the through hole 11, the rod 3 is turned together with both adapters 2 for the locking bit 23 to engage a selected locking channel 13 for the object 4 suspended from the rod 3 for application with the trunk 5.

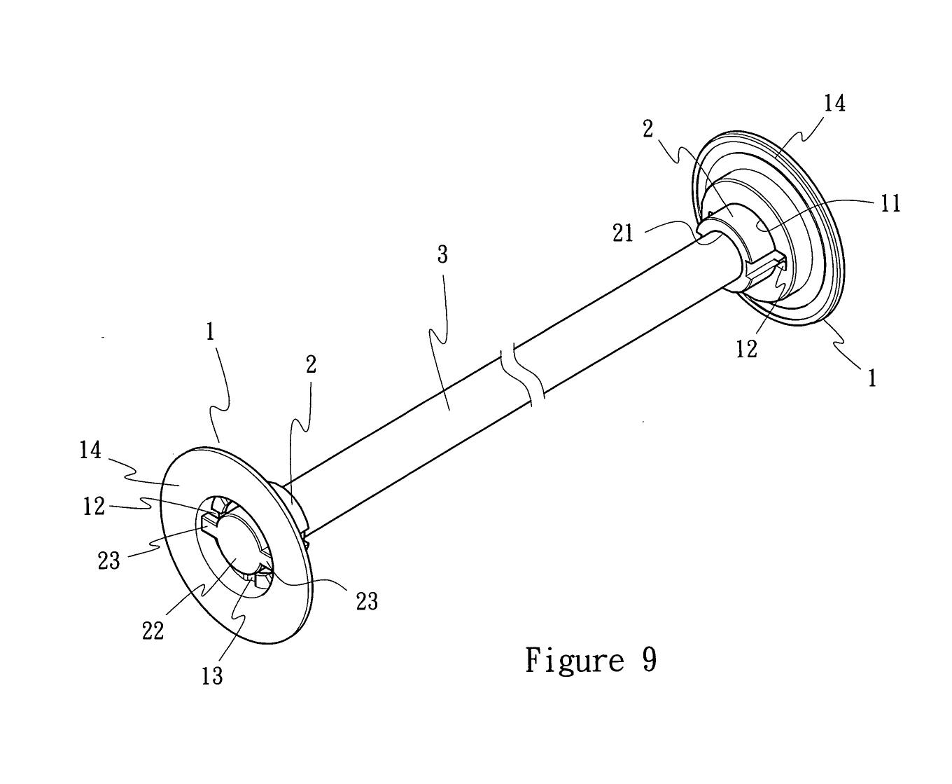

While those locking holes 141 on the flange 14 are either locked or riveted to the trunk 5, the flange 14 of the base 1 may be made of a soft material different from that for the base 1 so to allow the base 1 to be sewn to the flange 14 to facilitate the fixation of the base 1 of the present invention to the trunk 5 as illustrated in FIG. 9.

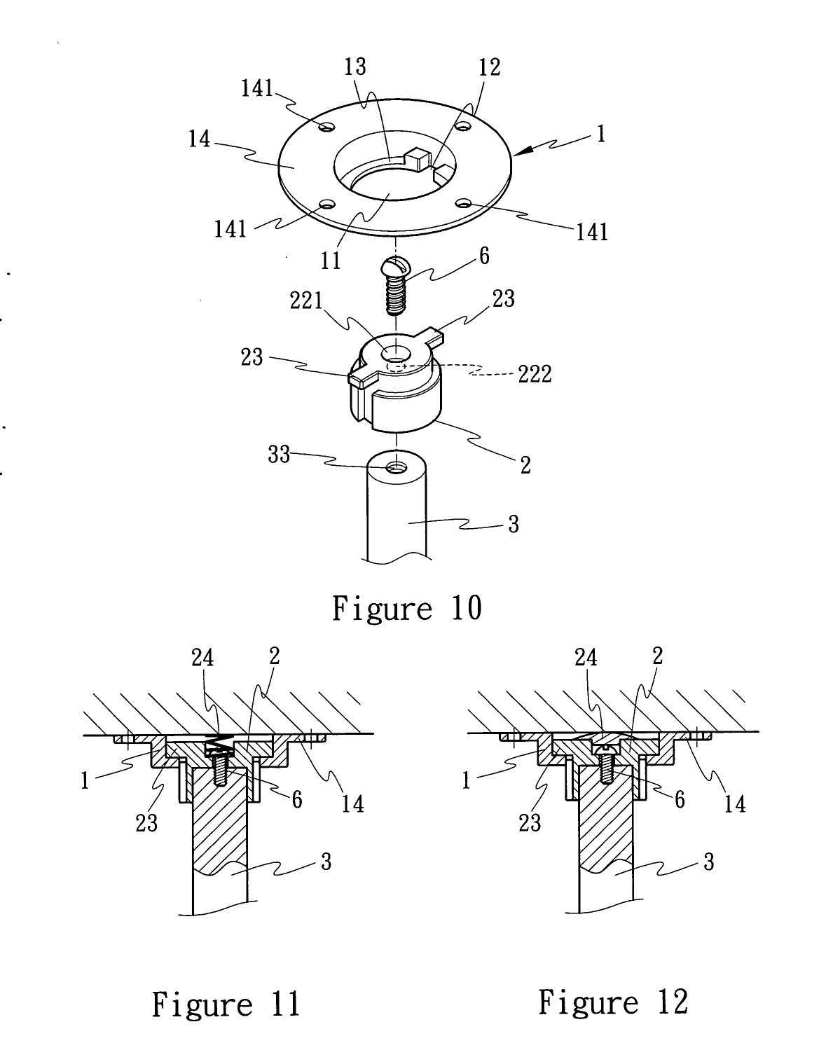

The adapter 2 is bound to the rod 3 either by gluing or by having both of the slot 31 and the limiting bit 211 latched to each other. Alternatively, a trough 221 is provided to the cap 22 at the top of the adapter 2, and a through hole 222 is disposed in the trough 221 as illustrated in FIG. 10. A screwed hole 33 is disposed to the end of the rod 3 so that once the adapter 2 is inserted to the rod 3, a screw 6 passes through the through hole 222 and is locked into the screwed hole 33 to secure the adapter 2 to the rod 3. Meanwhile, an elastic member 24 in the form of a coil as illustrated in FIG. 11 or a rubber as illustrated in FIG. 12 is mounted in the trough 221 for the locking bit 23 of the adapter 2 and the locking channel 13 of the base are latched to each other without the risk of having the locking bit 23 to easily retreat from the locking channel 13 to firmly secure the adapter 2 to the base 1.

What is claimed is:

1. A retractable hanger with its hanging angle adjustable includes a base, an adapter, and a rod; the base related to a disk and flanged, having at its center a through hole, one gap each being provided on both sides of the inner wall therein; and multiple locking channels being disposed on the inner circumference of the through hole; the adapter approximately in a shape of a disk, having a recess disposed at the bottom, and a cap in smaller diameter formed at the top with a locking bit each extending from both sides at the top of the cap; the rod to hang an object being made in a diameter corresponding to that of the recess of the adapter; the base being fixed to a designated location with its flange; the head of the rod being connected into the recess of the adapter; the locking bit of the adapter passing through both gaps in the through hole of the base and turned together with the adapter; and the positioning bit being latched to a selected locking channel.

2. The retractable hanger of claim 1, wherein one adapter is each connected to both ends of the rod; and the rod is laterally fixed to two bases fixed on the inner edge of an opening of a trunk for the trunk to hang a bag.

3. The retractable hanger of claim 1, wherein each locking channel disposed in the base is arranged in radius on the inner circumference of the through hole in the base with the through hole as the center.

4. The retractable hanger of claim 1, wherein the flange of the base is made of a soft material different from that for the base.

5. The retractable hanger of claim 1, wherein multiple locking holes are provided on the flange of the base.

6. The retractable hanger of claim 1, wherein one or a plurality of limiting bit is provided on the inner wall at the bottom of the recess of the adapter; a slot is each provided on both ends of the rod; and both of the limiting bit and the slot are engaged to each other.

7. The retractable hanger of claim 1, wherein the tail of the rod is formed a hooker.

8. The retractable hanger of claim 1, wherein a trough is provided to the cap at the top of the adapter; a through hole is disposed in the trough; a screwed hole is disposed on the end of the rod; and a screw passing through the through hole locks into the screwed hole.

9. The retractable hanger of claim 8, wherein an elastic member is mounted in the trough.
